(19) United States
(12) Patent Application Publication
(10) Pub. No.: US 2002/0155864 A1
(43) Pub. Date: Oct. 24, 2002

(54) Modular mobile communication device

(76) Inventor: Shun-Ping Wang, Taipei (TW)

Correspondence Address: BIRCH STEWART KOLASCH & BIRCH, PO BOX 747, FALLS CHURCH, VA, 22040-0747, US

(21) Appl. No.: 09/836,220

(22) Filed: Apr. 18, 2001

(51) Int. Cl. H04B 1/38

(52) U.S. Cl. 455/566; 455/557; 455/575; 455/90

(57) ABSTRACT

A modular mobile communication device for performing one-on-one signal communication has a detachable display device and a communication device to enable users to select different assembly configurations desired. This invention adapts a modular design to divide the mobile communication device in a separated communication module and a display module. The communication module may function independently as an one-on-one communication device or couple with the display module for displaying data processed by the communication module.

### FIELD OF THE INVENTION

This invention relates to a modular mobile communication device for providing one-on-one communication function and particularly a device that adapts modular design for enhancing expandability of mobile communication devices.

### BACKGROUND OF THE INVENTION

The increasing inter-person activities in modern times have resulted in rapid growth of mobile phone systems and handsets. Almost any one can make one-on-one communication economically at two locations nowadays. As a result, mobile phone has become a very popular personal communication device.

The mobile phones now being used mostly have a body about the size of a human palm. The body includes a communication process unit for performing one-on-one communication. The front side of the body has, from top to bottom, an antenna, a display unit and a plurality of button keys. At the rear side of the body, there is a chamber for housing a Subscriber Identity Module (SIM) Card and a rechargeable battery. The antenna is for receiving and emitting signals, the button keys include numeral keys (or character keys), receiving key, cutoff key and selection key for respectively input telephone phone number and data, dialing phone number, receiving incoming signal or cutting off incoming signal. The display unit may display data regard the communication system, receiving signal power, battery power and built-in information and the like. Almost all the presently available mobile phones employ Liquid Crystal Display (LCD) unit for display which is a delicate device and cannot withstand heavy pressure or impact. Incidental dropping of the mobile phone could easily cause damage of the LCD unit and result in not functioning of the display device even though the communication function of the mobile phone remains intact. In such an situation, users have to buy a new mobile phone for replacement.

Another mobile phone purchasing consideration for users is the amount of standby time available. There are generally two ways to increase the standby time frame. One is to increase capacity of the rechargeable battery. Another is to reduce power consumption during the standby time period. For the ordinary mobile phones, the most power consuming item during the standby time is the display device because it continuously shows the data. Hence to reduce power consumption of the display device is one way to increase standby time frame.

Because of fast paced technology innovation and fierce competition among the mobile phone manufacturers, a prolific of new and function-rich mobile phones have been developed and introduced on the market constantly. For instance, it has evolved from a simple one-on-one communication to Wireless Application Protocol (WAP) mobile phones which are able to access and browse Internet. However the small size display device on the mobile phone is a severe limitation for WAP applications. A detachable and larger size display device would be a great help to resolve this problem.

### SUMMARY OF THE INVENTION

It is therefore an object of this invention to provide a modular mobile communication device that constitutes a detachable communicating device and display device.

The communication device according to this invention includes a communication module and a display module. The communication module may function independently to perform one-on-one communication. The display module may be selectively engaged with or detached from the communication module for displaying data processed by the communication module. In the event of the display module being damaged, users may replace only the display module without the need to buy a whole new set of mobile phone. Furthermore, during standby time, the display module may be detached from the communication module for reducing power consumption and increasing useable time of the communication module. Moreover, users may select larger size display module for WAP applications and browsing WAP sites information.

### BRIEF DESCRIPTION OF THE DRAWINGS

The invention, as well as its many advantages, may be further understood by the following detailed description and drawings. The drawings are only to serve for reference and illustrative purpose, and do not intend to limit the scope of the present invention.

FIG. 1 is a perspective view of this invention, at a detached state.

FIG. 2 is a perspective view of this invention, at an engaged state.

FIG. 3 is a construction block diagram of this invention.

FIG. 4 is another construction block diagram of this invention.

FIG. 5 is a yet another construction block diagram of this invention.

FIG. 6 is a perspective view of another embodiment of this invention.

FIG. 7 is a perspective view of a further embodiment of this invention.

### DESCRIPTION OF THE PREFERRED EMBODIMENTS

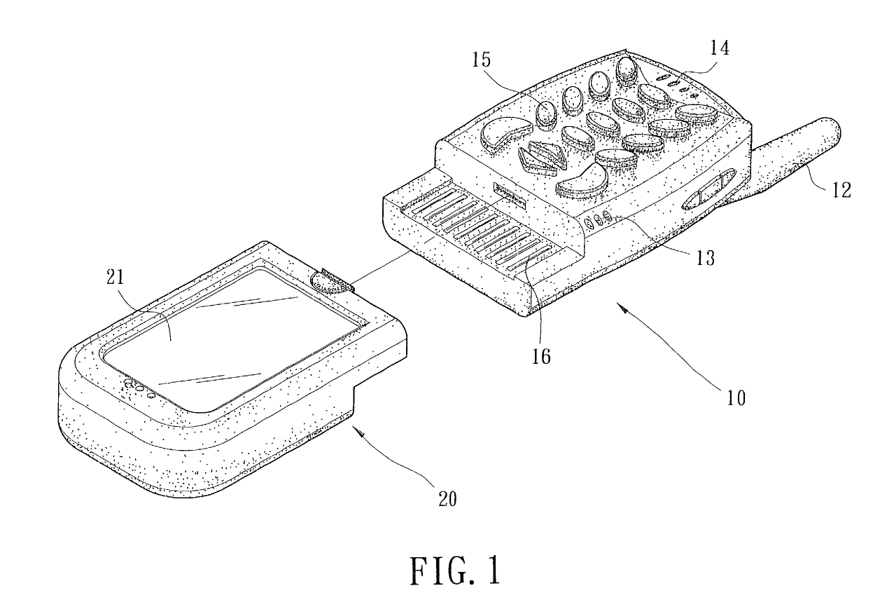

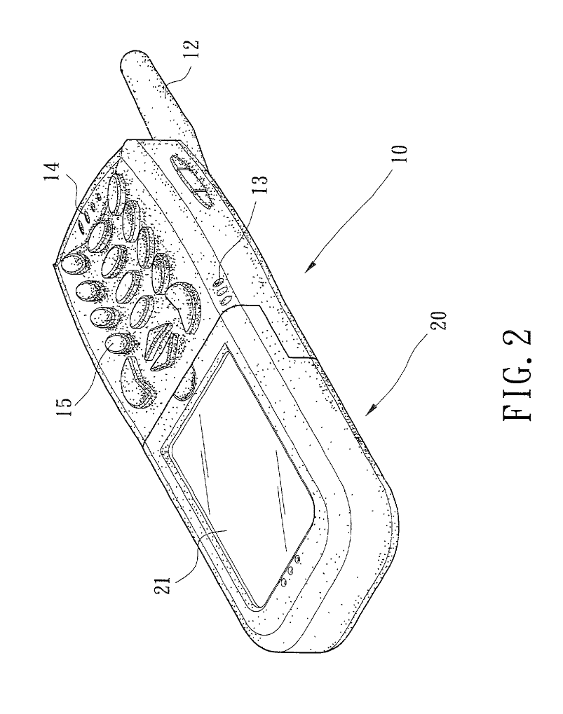

Referring to FIGS. 1 and 2, the modular mobile communication device according to this invention includes a communication module 10 and a display module 20.

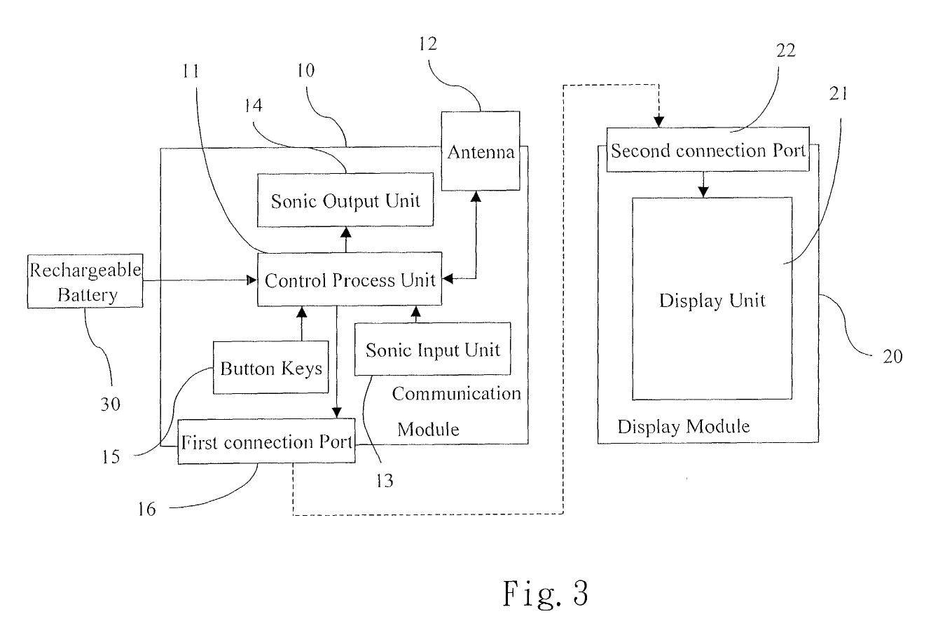

The communication module 10 includes at least a control process unit 11, an antenna 12, a sonic input unit 13, a sonic output unit 14, a plurality of button keys 15 and a first connection port 16 (also shown in FIG. 3. The technical principle and electric circuit for the construction sets forth above are known in the art, their details will be omitted herein). The control process unit 11 is for managing data and processing signals. The antenna 12 links to the control process unit 11 for receiving or emitting signals. The sonic input unit 13 is a microphone located at a lower end of the communication module 10 and is linked to the control process unit 11 for receiving user's verbal sound. The sonic output unit 14 is a speaker located at an upper end of the communication module 10 and is linked to the control process unit 11 for the user to hear the receiving sound. The button keys 15 include numeral keys (or character keys), receiving key, cutoff keys and selection keys linked to the control process unit 11 for input telephone number and telephone directory data, dialing outgoing telephone, receiving incoming telephone, or cutting off incoming signals. The first connection port 16 links to the control process unit 11 for establishing communication path for input or output signals. All the foregoing units are powered by a rechargeable battery 30 and form an independent assembly which is able to perform one-on-one communication.

The display module 20 is a separated assembly includes a display unit 21 and a second connection port 22. The display unit 21 is a LCD display device for displaying data. The second connection port 22 links to the display unit 21 for establishing communication path for output or input signals.

Referring to FIGS. 1, 2 and 3, the communication module 10 and display module 20 are independent elements. The communication module 10 may perform one-on-one communication by itself. The display module 20 may be selectively engaged with the communication module 10 through coupling the second and first connection port 22 and 16. The rechargeable battery 30 provides all the electric power needed. The display module 20 can display data processed by the control process unit 11.

Because this invention adapts a detachable construction, users may select a combined or detached configuration of the communication module 10 and display module 20 to suit their needs and desires. When users want more standby time, they can choose an assembly without the display module 20 for reducing battery power consumption. In case the display module 20 is damaged, users may buy another display module 20 at a lower cost for replacement without the need to buy a whole new set of the mobile phone at a higher price.

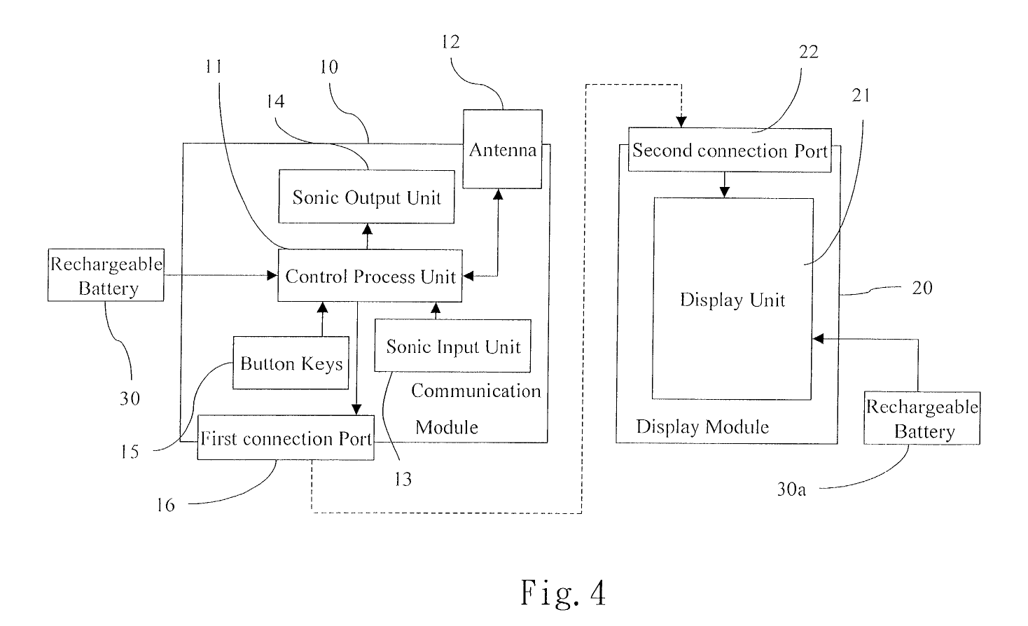

Referring to FIG. 4 for another embodiment of this invention, for increasing the standby time, an extra rechargeable battery 30a may be added to the display module 20 for supplying power needed in the display module 20, then the standby time of the communication module 10 may be increased.

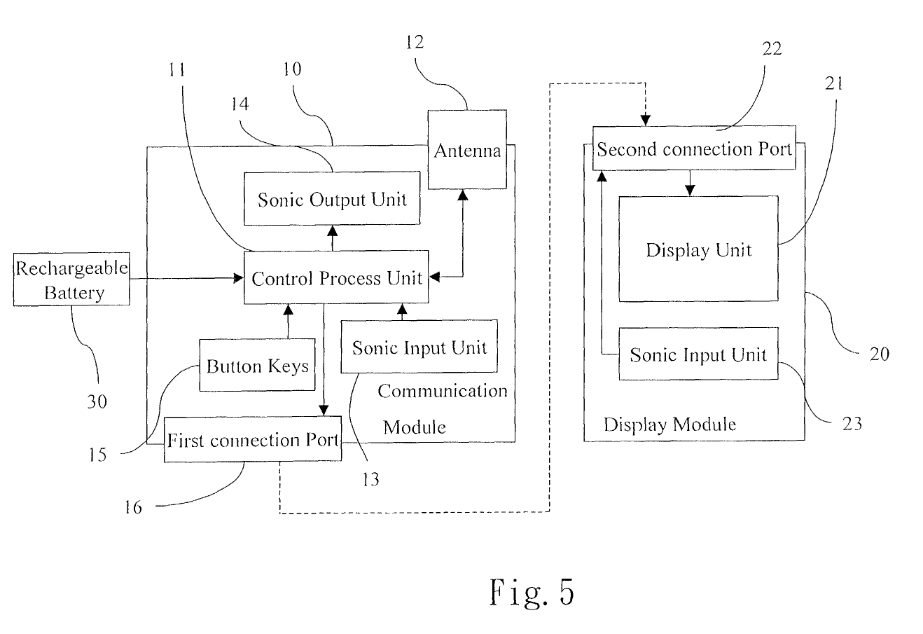

FIG. 5 illustrates yet another embodiment in which the display module 20 includes a sonic input unit 23 engaged to the second connection port 22. When the communication module 10 is coupled with the display module 20, the total mobile phone set has a greater length. Hence user may hear the incoming voice from the sonic output unit 14 at the communication module 10 and speak to the sonic input unit 23 at the display module 20 at more focused distances to the ear and mouth thereby to make communication more effective and comfortable.

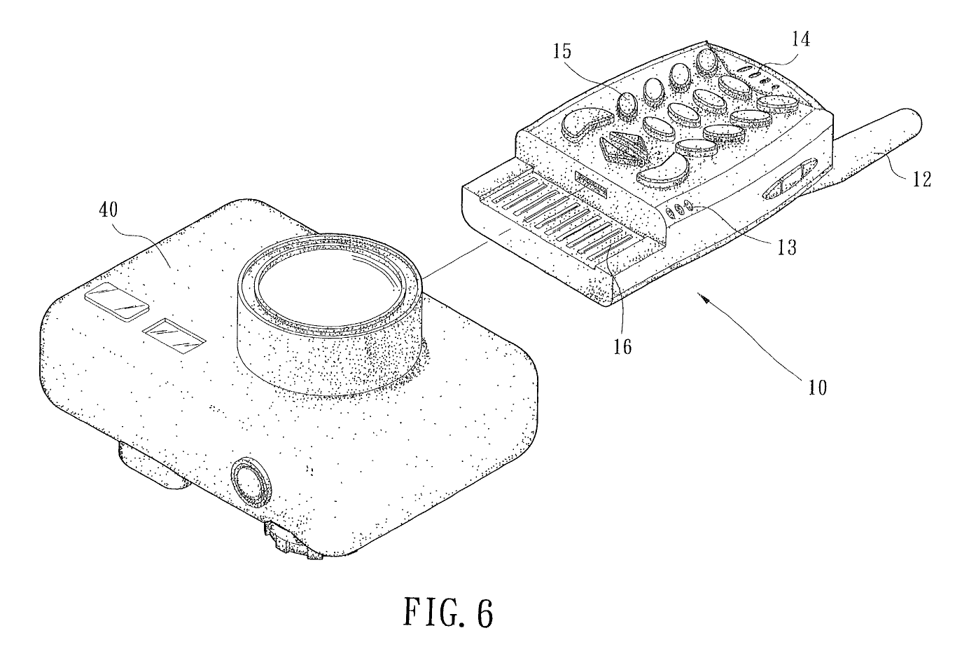

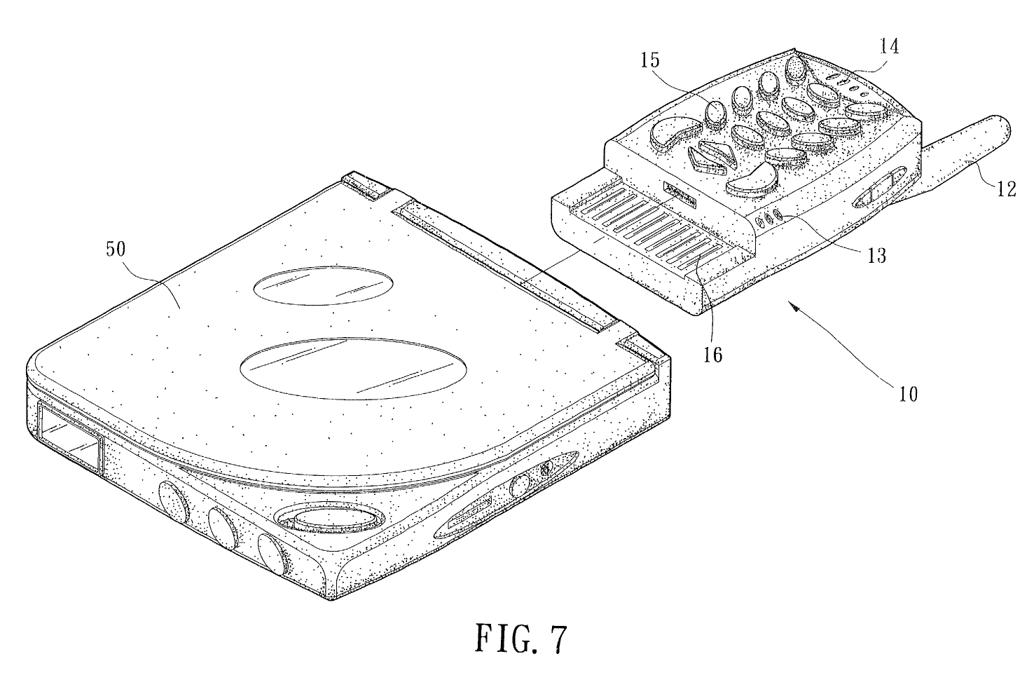

As the modular mobile communication device of this invention adapts a detachable design and construction, the communication module 10 may also be coupled with other electronic data process devices. FIG. 6 shows an embodiment example in which the communication module 10 is coupled with a digital camera 40 through the first connection port 16. The image taken by the digital camera 40 may be transmitted to an external device desired through the communication module 10. FIG. 7 shows yet another embodiment example in which the communication module 10 is coupled with a MP3 device 50 for down loading MP3 formatted music through the communication module 10. The expandability of the communication module 3 thus may be greatly enhanced.

It may thus be seen that the objects of the present invention set forth herein, as well as those made apparent from the foregoing description, are efficiently attained. While the preferred embodiments of the invention have been set forth for purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A modular mobile communication device, comprising:
a communication module for performing one-on-one communication; and
a display module for selectively engaging with the communication module to establish signal connection therebetween for displaying data processed by the communication module.

2. The modular mobile communication device of claim 1 further comprising a power supply module for providing electric power needed for the device.

3. The modular mobile communication device of claim 2, wherein the power supply module is a rechargeable battery.

4. The modular mobile communication device of claim 2, wherein the power supply module is selectively engaged with the communication module.

5. The modular mobile communication device of claim 2, wherein the power supply module is selectively engaged with the display module.

6. The modular mobile communication device of claim 2, wherein the communication module at least includes a control process unit, an antenna, a sonic input unit, a sonic output unit, and a plurality of button keys.

7. The modular mobile communication device of claim 1, wherein the communication module and display module include respectively a connection port which is engageable with each other for transmitting signals.

8. The modular mobile communication device of claim 1, wherein the display module includes a display unit which is a liquid crystal display device.

9. The modular mobile communication device of claim 1, wherein the display module further includes a sonic input unit.

10. The modular mobile communication device of claim 1, wherein the communication module is engageable with a digital camera for the digital camera to transmit data.

11. The modular mobile communication device of claim 1, wherein the communication module is engageable with a MP3 device for the MP3 device to transmit data.
